(19) United States
(12) Patent Application Publication
(10) Pub. No.: US 2022/0353316 A1
(43) Pub. Date: Nov. 3, 2022

(54) COMMUNICATION DEVICE, COMMUNICATION METHOD, AND NON-TRANSITORY COMPUTER-READABLE RECORDING MEDIUM

(71) Applicant: Woven Planet Holdings, Inc., Tokyo (JP)

(72) Inventors: Takahiro ITO, Tama-shi (JP); Naoya Kaneko, Kita-ku (JP)

(73) Assignee: Woven Planet Holdings, Inc., Tokyo (JP)

(21) Appl. No.: 17/733,432

(22) Filed: Apr. 29, 2022

(30) Foreign Application Priority Data
Apr. 30, 2021 (JP) 2021-077167

(51) Int. Cl. H04L 65/613; H04L 47/80; H04L 65/80; G06F 3/01

(52) U.S. Cl. CPC H04L 65/613; H04L 47/801; H04L 65/80; G06F 3/013

(57) ABSTRACT

A communication device is installed on a moving body and capable of communicating with an external device via a plurality of communication lines. The communication device includes a controller. The controller acquires a plurality of video streaming data acquired by a plurality of cameras installed on the moving body. The controller dynamically sets priority of the plurality of video streaming data. The controller acquires priority of the plurality of communication lines. The controller sets an allocation relationship between the plurality of video streaming data and the plurality of communication lines such that a video streaming data with higher priority is allocated to a communication line with higher priority. The controller transmits the plurality of video streaming data to the external device via the respectively allocated communication lines.

### CROSS-REFERENCE TO RELATED APPLICATION

This application claims priority to Japanese Patent Application No. 2021-077167 filed on Apr. 30, 2021, the entire contents of which are incorporated by reference herein.

### BACKGROUND

### Technical Field

The present disclosure relates to a communication technique applied to a moving body.

### Background Art

Patent Literature 1 discloses an in-vehicle communication device. The in-vehicle communication device supports both a mobile communication method and a WiFi communication method. When an abnormality of the vehicle is detected, the in-vehicle communication device transmits numerical data and image data indicating a vehicle travel status to a specified server. At this time, the in-vehicle communication device transmits the numerical data by the mobile communication method and transmits the image data by the WiFi communication method.

### LIST OF RELATED ART

Patent Literature 1: Japanese Laid-Open Patent Application Publication No. JP-2018-120443

### SUMMARY

A situation where a moving body such as a vehicle and a robot externally transmits a plurality of video streaming data acquired by a plurality of cameras is considered. When the plurality of video streaming data are simultaneously transmitted through a single communication line and a communication rate of the single communication line is decreased, qualities of the plurality of video streaming data may be deteriorated uniformly.

An object of the present disclosure is to provide a technique capable of appropriately transmitting a plurality of video streaming data acquired by a moving body while avoiding uniform deterioration in data quality.

A first aspect is directed to a communication device that is installed on a moving body and capable of communicating with an external device via a plurality of communication lines.

The communication device includes a controller.

The controller is configured to:

acquire a plurality of video streaming data acquired by a plurality of cameras installed on the moving body;

dynamically set priority of the plurality of video streaming data;

acquire priority of the plurality of communication lines;

set an allocation relationship between the plurality of video streaming data and the plurality of communication lines such that a video streaming data with higher priority is allocated to a communication line with higher priority; and

transmit the plurality of video streaming data to the external device via the respectively allocated communication lines.

A second aspect is directed to a communication method performing a communication between a moving body and an external device via a plurality of communication lines.

The communication method includes:

acquiring a plurality of video streaming data acquired by a plurality of cameras installed on the moving body;

dynamically setting priority of the plurality of video streaming data;

acquiring priority of the plurality of communication lines;

setting an allocation relationship between the plurality of video streaming data and the plurality of communication lines such that a video streaming data with higher priority is allocated to a communication line with higher priority; and

transmitting the plurality of video streaming data to the external device via the respectively allocated communication lines.

A third aspect is directed to a communication program executed by a computer installed on a moving body.

The moving body is capable of communicating with an external device via a plurality of communication lines.

The communication program causes the computer to execute:

acquiring a plurality of video streaming data acquired by a plurality of cameras installed on the moving body;

dynamically setting priority of the plurality of video streaming data;

acquiring priority of the plurality of communication lines;

setting an allocation relationship between the plurality of video streaming data and the plurality of communication lines such that a video streaming data with higher priority is allocated to a communication line with higher priority; and

transmitting the plurality of video streaming data to the external device via the respectively allocated communication lines.

According to the present disclosure, the communication device of the moving body is capable of using the plurality of communication lines. The plurality of video streaming data acquired by the moving body are transmitted from the moving body to the external device via the plurality of communication lines. It is therefore possible to avoid the uniform deterioration in data quality of the plurality of video streaming data.

Furthermore, according to the present disclosure, the priority of the plurality of video streaming data is dynamically set. Then, the video streaming data with higher priority is transmitted by the communication line with higher priority. Therefore, a communication requirement of the video streaming data with higher priority is preferentially secured. That is, it is possible to appropriately transmit the plurality of video streaming data to the external device.

### BRIEF DESCRIPTION OF DRAWINGS

FIG. 1 is a conceptual diagram showing an outline of a communication system according to an embodiment of the present disclosure;

FIG. 2 is a conceptual diagram for explaining an application example of a communication system according to an embodiment of the present disclosure;

FIG. 3 is a block diagram showing a configuration example of a communication system according to an embodiment of the present disclosure;

FIG. 4 is a block diagram showing a concrete example of a communication system according to an embodiment of the present disclosure;

FIG. 5 is a conceptual diagram showing an example of a moving body provided with a plurality of cameras according to an embodiment of the present disclosure;

FIG. 6 is a block diagram showing a functional configuration example of a communication controller installed on a moving body according to an embodiment of the present disclosure;

FIG. 7 is a flow chart showing a streaming communication process considering priority according to an embodiment of the present disclosure;

FIG. 8 is a conceptual diagram for explaining a first example of dynamic setting of streaming priority according to an embodiment of the present disclosure;

FIG. 9 is a conceptual diagram for explaining a first example of dynamic setting of streaming priority according to an embodiment of the present disclosure;

FIG. 10 is a conceptual diagram for explaining a second example of dynamic setting of streaming priority according to an embodiment of the present disclosure; and

FIG. 11 is a conceptual diagram for explaining a third example of dynamic setting of streaming priority according to an embodiment of the present disclosure.

### EMBODIMENTS

Embodiments of the present disclosure will be described with reference to the accompanying drawings.

### 1. COMMUNICATION SYSTEM

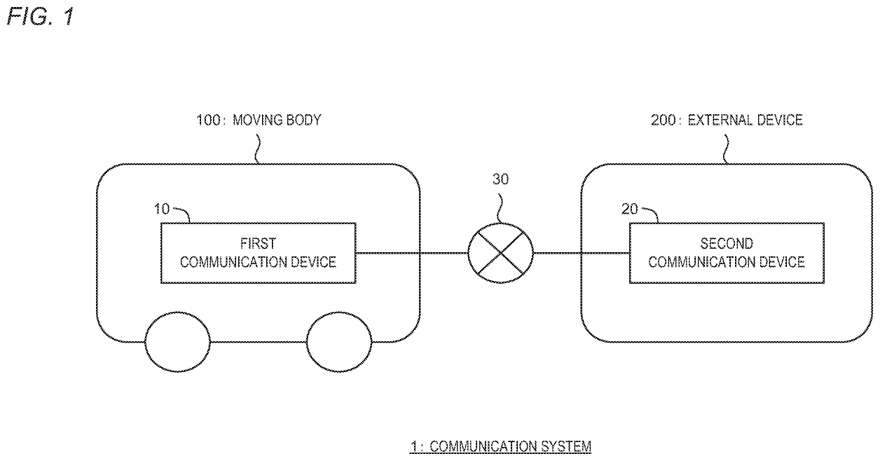

FIG. 1 is a conceptual diagram showing an outline of a communication system 1 according to the present embodiment. The communication system 1 includes a first communication device 10, a second communication device 20, and a communication network 30. The first communication device 10 and the second communication device 20 are connected to each other via the communication network 30. The first communication device 10 and the second communication device 20 is able to communicate with each other via the communication network 30.

In the present embodiment, at least one of the first communication device 10 and the second communication device 20 is installed on a moving body. Examples of the moving body include a vehicle, a robot, a flying object, and the like. The vehicle may be an automated driving vehicle or a vehicle driven by a driver. Examples of the robot include a logistics robot, a work robot, and the like. Examples of the flying object include an airplane, a drone, and the like.

In the following description, the first communication device 10 is installed on a moving body 100. The second communication device 20 is installed on an external device 200 outside the moving body 100. A type of the external device 200 is not limited in particular. For example, the external device 200 is a management server for managing the moving body 100. As another example, the external device 200 may be a remote support device that remotely supports an operation of the moving body 100. As yet another example, the external device 200 may be a moving body different from the moving body 100. Typically, the first communication device 10 of the moving body 100 and the second communication device 20 of the external device 200 performs a wireless communication. However, the present embodiment is not limited to the wireless communication.

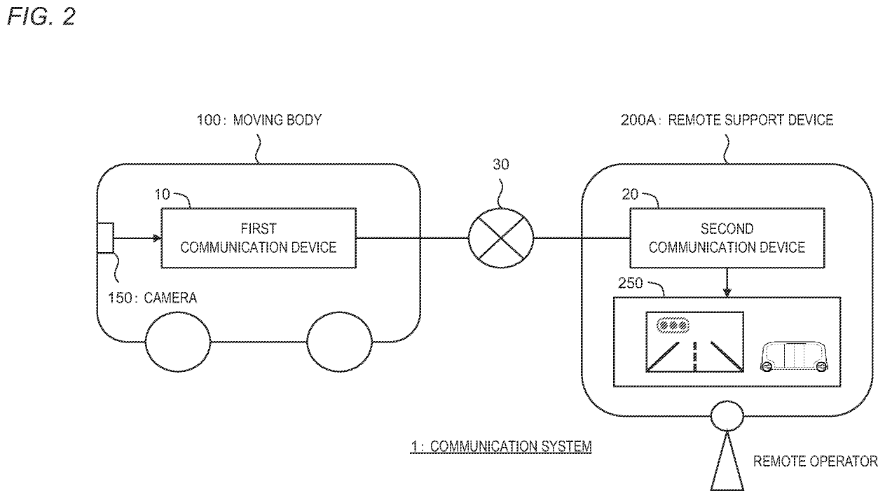

FIG. 2 is a conceptual diagram for explaining an application example of the communication system 1 according to the present embodiment. In the example shown in FIG. 2, the communication system 1 is utilized for “remote support” that remotely supports an operation of the moving body 100. More specifically, a camera 150 is installed on the moving body 100. The camera 150 images a situation around the moving body 100 to acquire image information. The first communication device 10 transmits the image information to a remote support device 200A being an example of the external device 200. The second communication device 20 of the remote support device 200A receives the image information from the moving body 100. The remote support device 200A displays the received image information on a display device 250. A remote operator looks at the image information displayed on the display device 250 to grasp the situation around the moving body 100 and remotely support the operation of the moving body 100. Examples of the remote support by the remote operator include recognition support, judgement support, remote driving, and the like. An instruction from the remote operator is transmitted from the second communication device 20 to the first communication device 10 of the moving body 100. The moving body 100 operates according to the instruction from the remote operator.

A variety of streaming data may be transmitted from the moving body 100 to the external device 200. For example, in the case of the remote support shown in FIG. 2, a video streaming data acquired by the camera 150 is transmitted. It is also conceivable that a plurality of video streaming data respectively acquired by a plurality of cameras 150 are transmitted simultaneously. In addition, an audio streaming data acquired by a microphone installed on the moving body 100 may be transmitted.

The first communication device 10 of the moving body 100 according to present embodiment is configured to be capable of communicating with the external device 200 via a plurality of communication lines. Since the number of communication lines that can be used simultaneously is increased, it becomes easy to ensure a communication rate as a whole, that is, data quality as a whole. The first communication device 10 transmits the plurality of streaming data to the external device 200 by using a necessary number of communication lines among the plurality of communication lines.

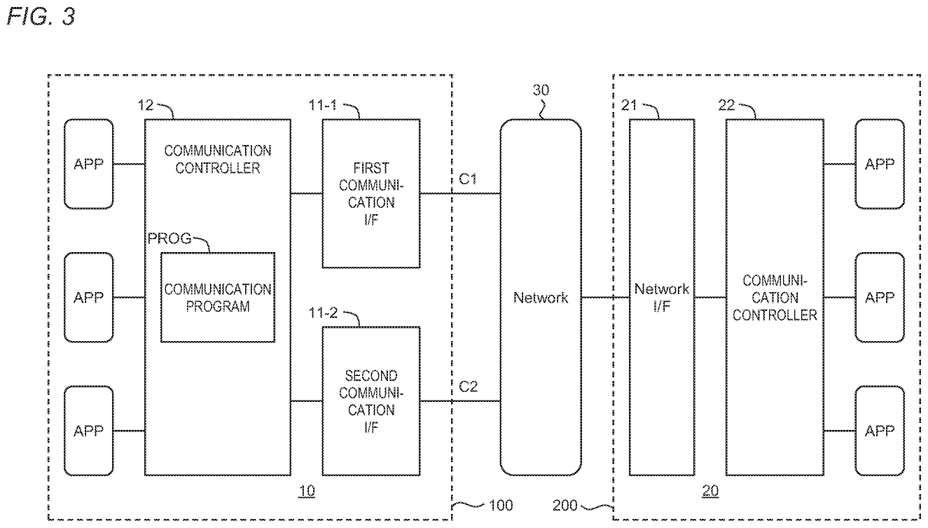

FIG. 3 is a block diagram showing a configuration example of the communication system 1 according to the present embodiment.

The first communication device 10 supports multiple types of communication methods (communication systems, communication protocols). Examples of the communication method include a common cellular method provided by MNO (Mobile Network Operator), an inexpensive cellular method provided by MVNO (Mobile Virtual Network Operator), a wireless LAN (Local Area Network) method, and the like. A communication cost differs among the multiple types of communication methods. In the example above, the wireless LAN method is the lowest and the common cellular method is the highest.

As shown in FIG. 3, the first communication device 10 includes a plurality of communication interfaces 11 and a communication controller 12.

The plurality of communication interfaces 11 are connected to the communication network 30 and perform communications with the second communication device 20 based on the multiple types of communication methods, respectively. For example, a first communication interface 11-1 performs a communication based on a first communication method. A second communication interface 11-2 performs a communication based on a second communication method different from the first communication method. It should be noted that the plurality of communication interfaces 11 may be realized by different physical interfaces, or may be realized by a combination of a common physical interface and different logical interfaces.

The plurality of communication lines are established based on the multiple types of communication methods, respectively. That is, the plurality of communication lines are associated with the multiple types of communication methods, respectively. It can also be said that the plurality of communication lines are associated with the plurality of communication interfaces 11, respectively. The plurality of communication interfaces 11 communicate with the second communication device 20 via the plurality of communication lines, respectively. For example, the first communication interface 11-1 performs the communication via a first communication line C1 based on the first communication method. The second communication interface 11-2 performs the communication via a second communication line C2 based on the second communication method.

The communication controller 12 is provided to control data transmitted and received by at least one application running on the moving body 100. For example, the communication controller 12 acquires the streaming data transmitted from at least one application to the external device 200 (i.e., the second communication device 20). The communication controller 12 allocates the streaming data to one or more of the plurality of communication interfaces 11 to be used. Then, the communication controller 12 transmits the streaming data to the external device 200 via the allocated communication interface 11 (i.e., the allocated communication line).

Moreover, the communication controller 12 performs “congestion control” that reduces a quality of the streaming data, as necessary. For example, in the case of the image (video) streaming data, the congestion control reduces its quality by lowering a resolution or a frame rate. As another example, the congestion control may reduce the quality of the streaming data by changing a compression rate.

The communication controller 12 is realized, for example, by a cooperation of a computer and a computer program. The moving body 100 is provided with a computer including a processor and a memory device. The computer program that provides the functions of the communication controller 12 is hereinafter referred to as a “communication program PROG.” The communication program PROG is stored in the memory device. The functions of the communication controller 12 are realized by the processor (the computer) executing the communication program PROG. It should be noted that the communication program PROG may be recorded on a non-transitory computer-readable recording medium. The communication program PROG may be provided via a network.

The second communication device 20 includes a network interface 21 and a communication controller 22. The network interface 21 is connected to the communication network 30 and communicates with the first communication device 10.

The communication controller 22 is provided to control data transmitted and received by at least one application running on the external device 200. For example, the communication controller 22 receives via the network interface 21 the streaming data transmitted from the first communication device 10. Then, the communication controller 22 outputs the streaming data to a destination application.

The communication controller 22 is realized, for example, by a cooperation of a computer and a computer program. The external device 200 is provided with a computer including a processor and a memory device. The computer program is stored in the memory device. The functions of the communication controller 22 are realized by the processor (the computer) executing the computer program.

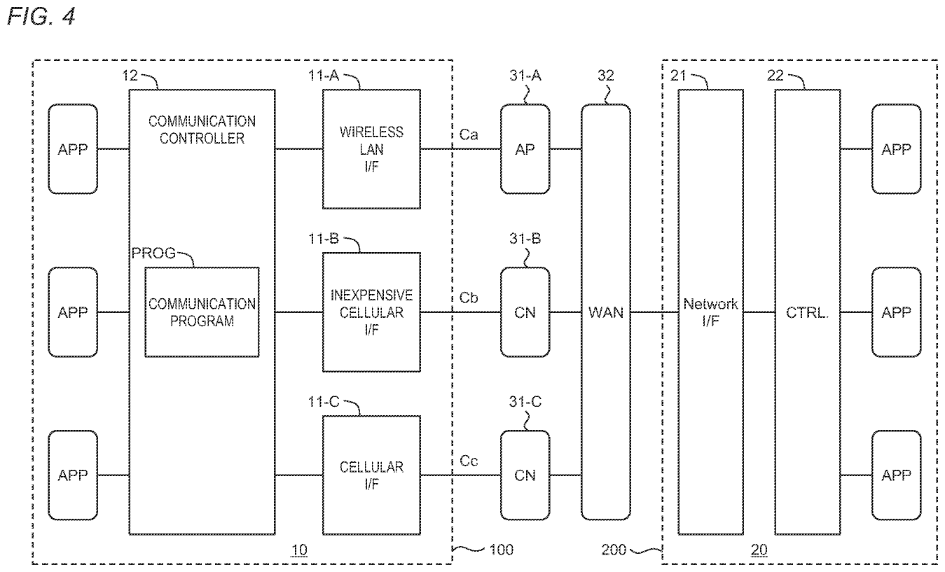

FIG. 4 is a block diagram showing a concrete example of the communication system 1 according to the present embodiment.

The plurality of communication interfaces 11 of the first communication device 10 include a wireless LAN interface 11-A, an inexpensive cellular interface 11-B, and a cellular interface 11-C. The wireless LAN interface 11-A performs a communication via a communication line Ca based on a wireless LAN method (system). The wireless LAN interface 11-A is connected to a communication network 32 (e.g., a WAN) via an access point 31-A. The inexpensive cellular interface 11-B performs a communication via a communication line Cb based on an inexpensive cellular method (system). The inexpensive cellular interface 11-B is connected to the communication network 32 via a cellular network 31-B. The cellular interface 11-C performs a communication via a communication line Cc based on a common cellular method (system). The cellular interface 11-C is connected to the communication network 32 via a cellular network 31-C.

In the case of the example shown in FIG. 4, the communication cost is lower in an order of the communication line Ca based on the wireless LAN method, the communication line Cb based on the inexpensive cellular method, and the communication line Cc based on the common cellular method.

### 2. STREAMING COMMUNICATION PROCESS CONSIDERING PRIORITY

Hereinafter, a case where a plurality of video streaming data are simultaneously transmitted from the moving body 100 to the external device 200 is considered. The plurality of video streaming data are respectively acquired by a plurality of cameras 150 installed on the moving body 100.

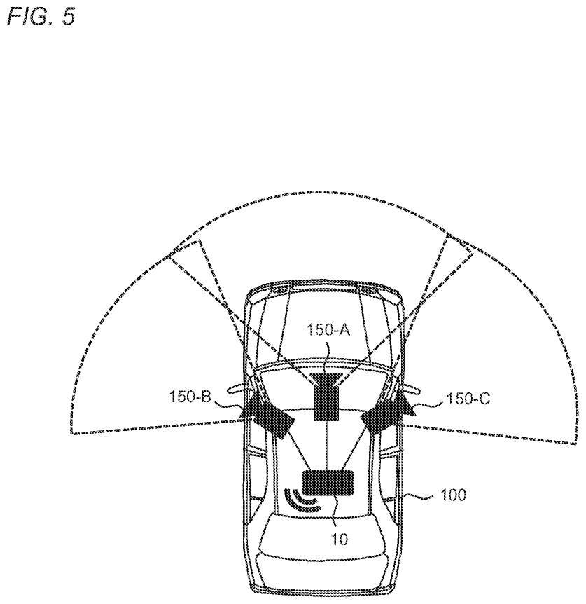

FIG. 5 shows an example of the moving body 100 provided with a plurality of cameras 150. In the example shown in FIG. 5, the moving body 100 is a vehicle. The vehicle is provided with a plurality of cameras 150-A to 150-C. A front camera 150-A is installed to image a front direction. A left camera 150-B is installed to image a left direction. A right camera 150-C is installed to image a right direction. A plurality of video streaming data indicating situations in the front, left, and right directions around the vehicle are acquired by the plurality of cameras 150-A to 150-C, respectively.

If the plurality of video streaming data are simultaneously transmitted through a single communication line and a communication rate of the single communication line is decreased, qualities of the plurality of video streaming data may be deteriorated uniformly. Such the uniform deterioration in data quality is not preferable in terms of use of the video streaming data.

In view of the above, according to the present embodiment, the plurality of video streaming data are transmitted from the moving body 100 to the external device 200 via the plurality of communication lines in order to avoid the uniform deterioration in data quality. Furthermore, according to the present embodiment, the plurality of video streaming data are allocated to the plurality of communication lines not blindly but in consideration of “priority.” In the following description, “streaming priority” means priority of the video streaming data, and “line priority” means priority of the communication line.

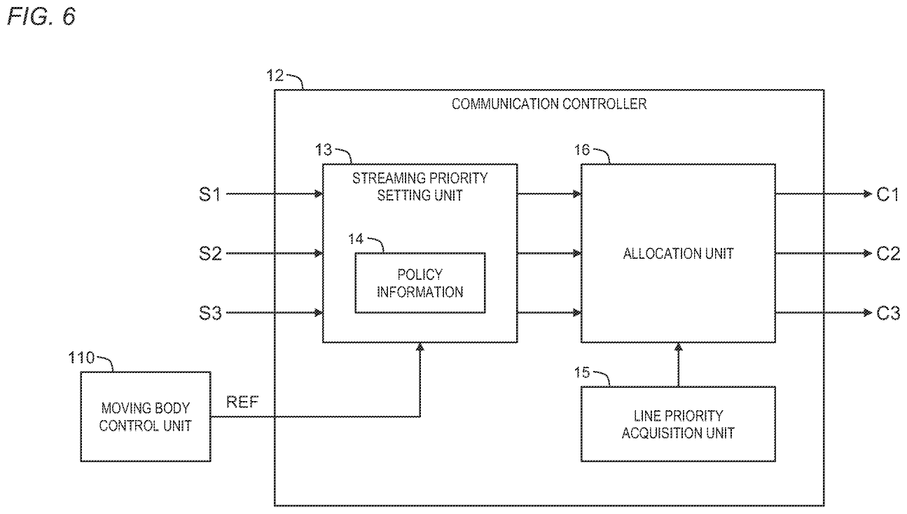

FIG. 6 is a block diagram showing a functional configuration example of the communication controller 12 of the first communication device 10 installed on the moving body 100. The communication controller 12 includes a streaming priority setting unit 13, a line priority acquisition unit 15, and an allocation unit 16. These functional blocks are realized by the processor executing the communication program PROG (see FIGS. 3 and 4).

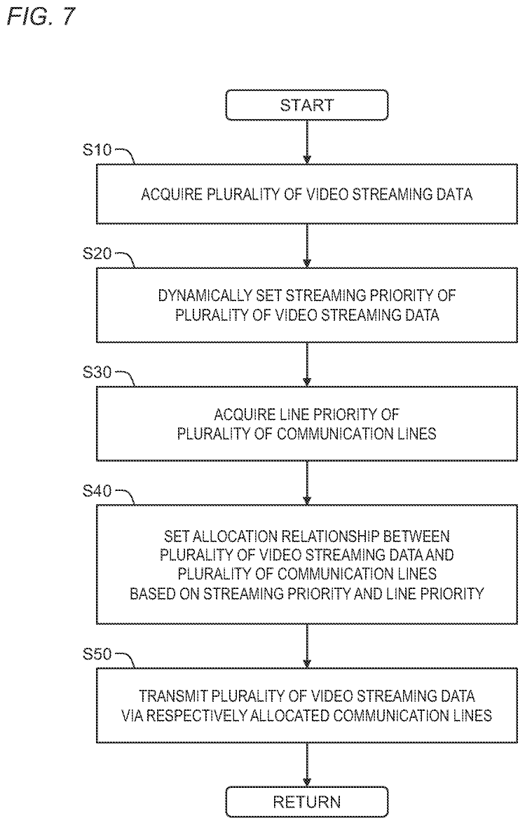

FIG. 7 is a flow chart showing a streaming communication process considering the priority. Hereinafter, the streaming communication process considering the priority according to the present embodiment will be described in detail with reference to FIGS. 6 and 7. As an example, a plurality of video streaming data S1, S2, and S3 and a plurality of communication lines C1, C2, and C3 are considered.

### 2-1. Step S10

In Step S10, the communication controller 12 acquires the plurality of video streaming data S1 to S3 acquired by the plurality of cameras 150 installed on the moving body 100.

### 2-2. Step S20

In Step S20, the streaming priority setting unit 13 sets the streaming priority of the plurality of video streaming data S1 to S3. In particular, the streaming priority setting unit 13 “dynamically” sets the streaming priority.

As an example, a case where the video streaming data S1 to S3 are transmitted to the remote support device 200A and used for the remote support by the remote operator (see FIG. 2). To which of the plurality of video streaming data S1 to S3 is mainly given attention by the remote operator varies dynamically depending on a situation of the moving body 100 and the like. In that case, from a viewpoint of the remote operator (remote support), the streaming priority of the video streaming data S1 to S3 is dynamically set according to a degree of necessity for each of the video streaming data S1 to S3.

Information used in the streaming priority setting unit 13 and concrete processing by the streaming priority setting unit 13 are as follows.

Identification information is stored in a header of each of the video streaming data S1 to S3. For example, the identification information indicates information of the camera 150 that acquires the video streaming data. As another example, the identification information indicates a type of the video streaming data. The streaming priority setting unit 13 discriminates between the video streaming data S1 to S3 based on the identification information.

Reference information REF is information that the streaming priority setting unit 13 refers to when dynamically setting the streaming priority. For example, the reference information REF indicates a situation of the moving body 100 that varies dynamically. Such the reference information REF is provided, for example, from a moving body control unit 110 that controls the moving body 100.

Policy information 14 indicates a “setting policy” about how the streaming priority is set in what situation. In other words, the policy information 14 is information that associates a content of the reference information REF and the streaming priority of the video streaming data S1 to S3 with each other. The policy information 14 is created in advance and stored in a memory device accessible by the communication controller 12.

In accordance with the setting policy indicated by the policy information 14, the streaming priority setting unit 13 dynamically sets the streaming priority according to the situation indicated by the reference information REF. Various examples of the dynamic setting of the streaming priority are conceivable. That is, various examples of the reference information REF and the setting policy are conceivable. Various examples of the dynamic setting of the streaming priority will be described later in detail.

### 2-3. Step S30

In Step S30, the line priority acquisition unit 15 acquires the line priority of the plurality of communication lines C1 to C3.

For example, the line priority is predetermined from a viewpoint of a communication cost of each communication line. In this case, the line priority becomes higher as the communication cost becomes lower. For example, when the communication cost of the first communication line C1 is lower than the communication cost of the second communication line C2, the line priority of the first communication line C1 is set to be higher than the line priority of the second communication line C2 (i.e., C1>C2). In the case of the example shown in FIG. 4, the communication cost is lower in an order of the communication line Ca based on the wireless LAN method, the communication line Cb based on the inexpensive cellular method, and the communication line Cc based on the common cellular method. Accordingly, the line priority is higher in the order of the communication lines Ca, Cb, and Cc (i.e., Ca>Cb>Cc). The line priority acquisition unit 15 acquires information of the line priority that is predetermined from the viewpoint of the communication cost.

As another example, the line priority is set from a viewpoint of a communication rate of each communication line. In this case, the line priority becomes higher as the communication rate becomes higher. The communication rate may be a theoretical value, an actual measured value, or an estimate value. For example, an actual measured value or an estimate value of a throughput is used as the communication rate. The throughput may be estimated by using an estimation model that is based on parameters such as region, time, and day of week. The estimation model may be generated through deep learning. Various methods of measuring or estimating the throughput have been proposed. In the present embodiment, the method is not limited in particular. The line priority acquisition unit 15 acquires information of the communication rate of each communication line and sets the line priority based on the communication rate.

As yet another example, the line priority is set from a viewpoint of a communication delay of each communication line. In this case, the line priority becomes higher as the communication delay becomes lower. The communication delay may be an actual measured value or may be an estimate value. Various methods of measuring or estimating the communication delay have been proposed. In the present embodiment, the method is not limited in particular. The line priority acquisition unit 15 acquires information of the communication delay of each communication line and sets the line priority based on the communication delay.

The line priority may be set based on a combination of two or more of the communication cost, the communication rate, and the communication delay. For example, the line priority of the first communication line C1 is the highest and the line priority of the third communication line C3 is the lowest in the following case.

First communication line C1: communication cost=low, communication rate=high, and communication delay=low

Second communication line C2: communication cost=middle, communication rate=high, and communication delay=low

Third communication line C3: communication cost=low, communication rate=low, and communication delay=high

As described above, the line priority acquisition unit 15 sets the line priority of the plurality of communication lines C1 to C3 based on at least one of the communication cost, the communication rate, and the communication delay. Which communication parameter is preferentially used for setting the line priority depends on a “communication requirement” required by a user. Which communication parameter is preferentially used for setting the line priority may be specified by a user.

### 2-4. Step S40

In Step S40, the allocation unit 16 sets an allocation relationship between the plurality of video streaming data S1 to S3 and the plurality of communication lines C1 to C3. In particular, the allocation unit 16 sets the allocation relationship between the plurality of video streaming data S1 to S3 and the plurality of communication lines C1 to C3 such that a video streaming data with higher streaming priority is allocated to a communication line with higher line priority.

As an example, a case where the streaming priority is “S1>S2>S3” and the line priority is “C1>C2>C3” is considered. In this case, the allocation unit 16 allocates the first video streaming data S1 to the first communication line C1, allocates the second video streaming data S2 to the second communication line C2, and allocates the third video streaming data S3 to the third communication line C3.

### 2-5. Step S50

In Step S50, the communication controller 12 transmits the plurality of video streaming data S1 to S3 to the external device 200 via the respectively allocated communication lines C1 to C3 (communication interfaces 11).

### 2-6. Effects

As described above, according to the present embodiment, the first communication device 10 of the moving body 100 is capable of using the plurality of communication lines. The plurality of video streaming data acquired by the moving body 100 are transmitted from the moving body 100 to the external device 200 via the plurality of communication lines. It is therefore possible to avoid the uniform deterioration in data quality of the plurality of video streaming data.

Furthermore, according to the present embodiment, the streaming priority of the plurality of video streaming data is dynamically set according to a situation. Then, the video streaming data with higher streaming priority is transmitted by the communication line with higher line priority. Therefore, the communication requirement of the video streaming data with higher streaming priority is preferentially secured. That is, it is possible to appropriately transmit the plurality of video streaming data to the external device 200.

For example, the plurality of video streaming data are transmitted to the remote support device 200A and used for the remote support by the remote operator (see FIG. 2). Accuracy of the remote support is improved because the uniform deterioration in data quality of the plurality of video streaming data is avoided and the communication requirement of the video streaming data with higher streaming priority is preferentially secured.

### 3. EXAMPLES OF DYNAMIC SETTING OF STREAMING PRIORITY

Hereinafter, various examples of the dynamic setting of the streaming priority according to the present embodiment will be described. Typically, from a viewpoint of the remote support (remote operator), the streaming priority is dynamically set according to a degree of necessity for each of the plurality of video streaming data.

### 3-1. First Example

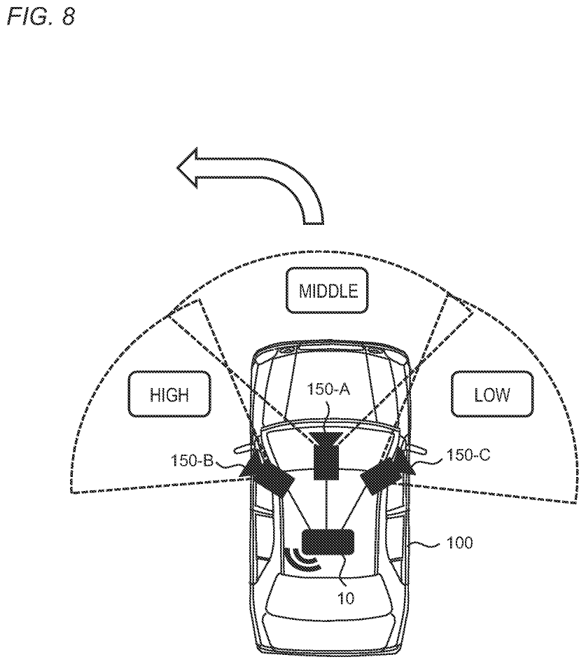

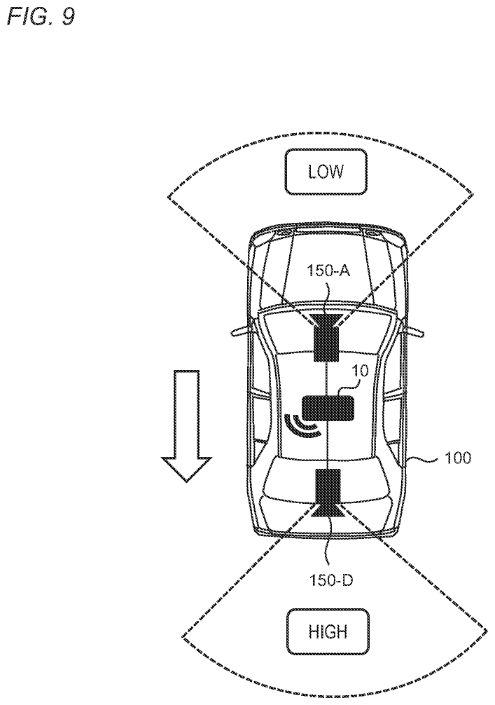

FIGS. 8 and 9 are conceptual diagrams for explaining a first example of the dynamic setting of the streaming priority.

In the first example, the reference information REF is information reflecting a “planned movement direction of the moving body 100.” For example, when the moving body 100 is a vehicle, the reference information REF includes at least one of a steering wheel steering direction, a steering wheel steering angle, blinker information, a gear position, and a wheel speed. As another example, the reference information REF may include a current position and a target travel route of the moving body 100. Such the reference information REF is provided from the moving body control unit 110 that controls the moving body 100.

The streaming priority setting unit 13 acquires the reference information REF from the moving body control unit 110 and recognizes the planned movement direction of the moving body 100 based on the acquired reference information REF. Then, the streaming priority setting unit 13 dynamically sets the streaming priority of the plurality of video streaming data based on the planned movement direction of the moving body 100. More specifically, the streaming priority setting unit 13 sets the streaming priority of a video streaming data of a direction closer to the planned movement direction higher than the streaming priority of a video streaming data of a direction farther from the planned movement direction.

In the example shown in FIG. 8, the moving body 100 (vehicle) is planned to make a left turn or is making a left turn, and the planned movement direction of the moving body 100 is the left direction. In this case, the video streaming data acquired by the left camera 150-B imaging the left direction is most important. Therefore, the streaming priority of the video streaming data acquired by the left camera 150-B is set to be highest. On the other hand, the streaming priority of the video streaming data acquired by the right camera 150-C imaging the right direction is set to be lowest.

In the example shown in FIG. 9, the moving body 100 (vehicle) is provided with the front camera 150-A that images the front direction and a rear camera 150-D that images a rear direction. When the moving body 100 moves forward, the streaming priority of the video streaming data acquired by the front camera 150-A is set to be higher than the streaming priority of the video streaming data acquired by the rear camera 150-D. To the contrary, when the moving body 100 moves backward, the streaming priority of the video streaming data acquired by the rear camera 150-D is set to be higher than the streaming priority of the video streaming data acquired by the front camera 150-A.

### 3-2. Second Example

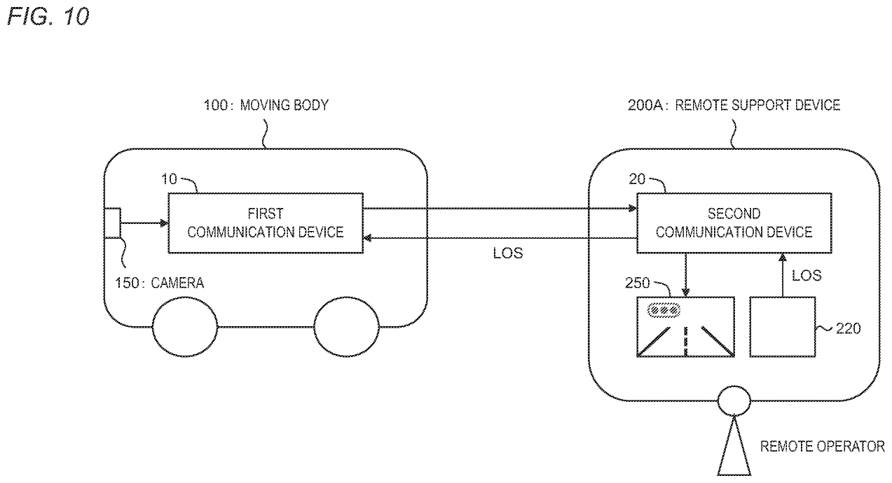

FIG. 10 is a conceptual diagram for explaining a second example of the dynamic setting of the streaming priority.

In the second example, the reference information REF indicates an “eye direction of the remote operator.” For example, the remote support device 200A is provided with an operator monitor 220 that detects the eye direction of the remote operator. The operator monitor 220 includes a camera that images eyes and a face of the remote operator. The operator monitor 220 detects the eye direction of the remote operator by analyzing an image of the remote operator captured by the camera. Then, the operator monitor 220 generates eye direction information LOS indicating the eye direction of the remote operator. The remote support device 200A transmits the eye direction information LOS to the moving body 100 via the second communication device 20. That is to say, the remote support device 200A feeds back the eye direction of the remote operator to the moving body 100.

The communication controller 12 of the moving body 100 receives the eye direction information LOS from the remote support device 200A. The streaming priority setting unit 13 receives the eye direction information LOS as the reference information REF and recognizes the eye direction of the remote operator. Then, the streaming priority setting unit 13 dynamically sets the streaming priority of the plurality of video streaming data based on the eye direction of the remote operator. More specifically, the streaming priority setting unit 13 sets the streaming priority of a video streaming data of a direction closer to the eye direction higher than the streaming priority of a video streaming data of a direction farther from the eye direction.

For example, when the eye direction of the remote operator is the left direction, the video streaming data acquired by the left camera 150-B imaging the left direction is most important. Therefore, the streaming priority of the video streaming data acquired by the left camera 150-B is set to be highest. On the other hand, the streaming priority of the video streaming data acquired by the right camera 150-C imaging the right direction is set to be lowest.

### 3-3. Third Example

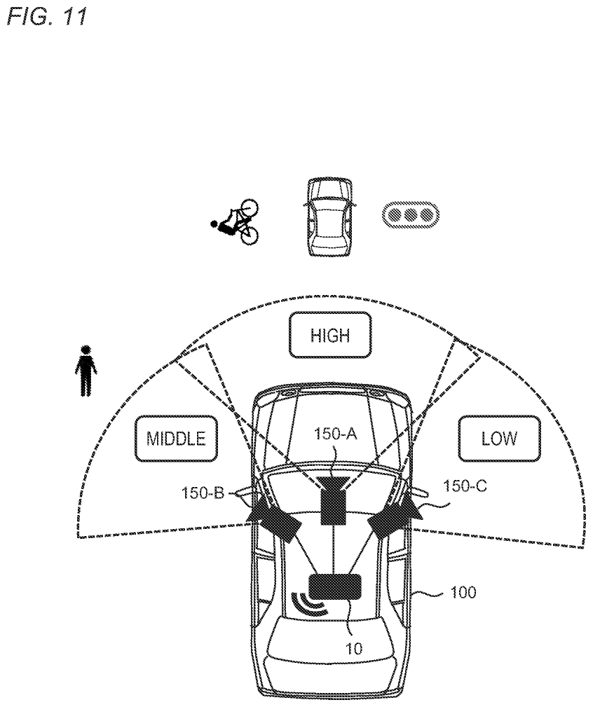

FIG. 11 is a conceptual diagram for explaining a third example of the dynamic setting of the streaming priority.

In the third example, a “specific object” shown in each video streaming data is taken into consideration. The specific object is an object that the remote operator is likely to focus on. For example, the specific object includes at least one of a pedestrian, a bicycle, another vehicle, a traffic light, and a sign. The reference information REF indicates types and numbers of the specific objects shown in each video streaming data.

For example, the moving body control unit 110 acquires the plurality of video streaming data acquired by the plurality of cameras 150. The moving body control unit 110 performs object recognition by analyzing images constituting each video streaming data, thereby acquiring the reference information REF. Then, the moving body control unit 110 provides the reference information REF to the streaming priority setting unit 13 of the communication controller 12.

As another example, the streaming priority setting unit 13 may perform the object recognition by analyzing images constituting each video streaming data, thereby acquiring the reference information REF.

The streaming priority setting unit 13 sets the streaming priority of a video streaming data showing a larger number of the specific object higher than the streaming priority of a video streaming data showing a smaller number of the specific object. In addition, weighting according to the type of the specific object may be performed. For example, weights of the pedestrian, the bicycle, and the traffic light are set to be relatively large.

In the example shown in FIG. 11, the streaming priority of the video streaming data acquired by the front camera 150-A is set to be highest. On the other hand, the streaming priority of the video streaming data acquired by the right camera 150-C imaging the right direction is set to be lowest.

What is claimed is:

1. A communication device that is installed on a moving body and capable of communicating with an external device via a plurality of communication lines,
the communication device comprising a controller configured to:
acquire a plurality of video streaming data acquired by a plurality of cameras installed on the moving body;
dynamically set priority of the plurality of video streaming data;
acquire priority of the plurality of communication lines;
set an allocation relationship between the plurality of video streaming data and the plurality of communication lines such that a video streaming data with higher priority is allocated to a communication line with higher priority; and
transmit the plurality of video streaming data to the external device via the respectively allocated communication lines.

2. The communication device according to claim 1, wherein
the controller is further configured to:
acquire information reflecting a planned movement direction of the moving body; and
dynamically set the priority of the plurality of video streaming data based on the planned movement direction of the moving body.

3. The communication device according to claim 2, wherein
the controller is further configured to set the priority of a video streaming data of a direction closer to the planned movement direction higher than the priority of a video streaming data of a direction farther from the planned movement direction.

4. The communication device according to claim 1, wherein
a specific object includes at least one of a pedestrian, a bicycle, another vehicle, a traffic light, and a sign, and
the controller is further configured to set the priority of a video streaming data showing a larger number of the specific object higher than the priority of a video streaming data showing a smaller number of the specific object.

5. The communication device according to claim 1, wherein
an operation of the moving body is remotely supported by a remote operator based on the plurality of video streaming data transmitted to the external device.

6. The communication device according to claim 5, wherein
the controller is further configured to:
acquire information indicating an eye direction of the remote operator from the external device; and
dynamically set the priority of the plurality of video streaming data based on the eye direction of the remote operator.

7. The communication device according to claim 6, wherein
the controller is further configured to set the priority of a video streaming data of a direction closer to the eye direction higher than the priority of a video streaming data of a direction farther from the eye direction.

8. The communication device according to claim 1, wherein
the controller is further configured to set the priority of the plurality of communication lines based on at least one of a communication cost, a communication rate, and a communication delay.

9. A communication method performing a communication between a moving body and an external device via a plurality of communication lines,
the communication method comprising:
acquiring a plurality of video streaming data acquired by a plurality of cameras installed on the moving body;
dynamically setting priority of the plurality of video streaming data;
acquiring priority of the plurality of communication lines;
setting an allocation relationship between the plurality of video streaming data and the plurality of communication lines such that a video streaming data with higher priority is allocated to a communication line with higher priority; and
transmitting the plurality of video streaming data to the external device via the respectively allocated communication lines.

10. A communication program executed by a computer installed on a moving body, wherein the moving body is capable of communicating with an external device via a plurality of communication lines,
the communication program causing the computer to execute:
acquiring a plurality of video streaming data acquired by a plurality of cameras installed on the moving body;
dynamically setting priority of the plurality of video streaming data;
acquiring priority of the plurality of communication lines;
setting an allocation relationship between the plurality of video streaming data and the plurality of communication lines such that a video streaming data with higher priority is allocated to a communication line with higher priority; and
transmitting the plurality of video streaming data to the external device via the respectively allocated communication lines.
